(19) United States
(12) Patent Application Publication
(10) Pub. No.: US 2009/0031021 A1
(43) Pub. Date: Jan. 29, 2009

(54) TRANSMITTING/RECEIVING METHOD OF SVC FILE AND APPARATUS THEREOF

(76) Inventors: Seong-Jun Bae, Seoul (KR); Yong-Ju Cho, Seoul (KR); Jae-Gon Kim, Daejeon-city (KR); Jin-Woo Hong, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 12/160,246

(22) PCT Filed: Jan. 9, 2007
(86) PCT No.: PCT/KR07/00165

§ 371 Date: Aug. 18, 2008

Related U.S. Application Data
(60) Provisional application No. 60/757,279, filed on Jan. 9, 2006.

(30) Foreign Application Priority Data
Dec. 8, 2006 (KR) 10-2006-0125050
Jan. 8, 2007 (KR) 10-2007-002188

(51) Int. Cl. G06F 15/16; G06F 15/173; G06F 17/30

(52) U.S. Cl. 709/224; 709/231; 707/1; 707/E17.001

(57) ABSTRACT

In the conventional content, a minimum access unit of the random access information is one frame unit. In the case of SVC video content, one frame consists of a plurality of scalable layers. The SVC data can be used for each salable layer only when the data is accessible for each scalable layer. The present invention provides a method and apparatus for transmitting and receiving an SVC file for each scalable layer wherein the SVC file can be accessed for each scalable layer by allowing metadata to contain a layer descriptor in a network abstraction layer unit (NALU) or in a byte unit.

### TECHNICAL FIELD

The present invention relates to a method and apparatus for transmitting and receiving a scalable video coding (SVC) file for each scalable layer, and more particularly, to a method and apparatus for transmitting and receiving an SVC file for each scalable layer wherein the SVC file can be accessed for each scalable layer by allowing metadata to contain a layer descriptor in a network abstraction layer unit (NALU) or in a byte unit.

### BACKGROUND ART

FIG. 1 is a view for explaining the concept of scalable video coding (SVC).

Referring to FIG. 1, in the SVC, a plurality of video layers are coded to obtain a single bit-stream.

An SVC layer consists of a basic layer and one or more enhancement layers which can be consecutively stacked on the basic layer.

According to lower layer information, each enhancement layer can represent its maximum bit rate, frame rate, and resolution.

In the SVC, the more the enhancement layers are consecutively stacked, the easier the bit rate, the frame rate, and the resolution can be provided in various forms.

Therefore, the SVC can solve a problem occurring in the use of a variety of bandwidths, a problem occurring in the use of a variety of capability and resolution of a receiving terminal, and a problem in the preference of content users.

FIG. 2 illustrates a configuration of a scalable layer of SVC data.

Referring to FIG. 2, a scalable base bit-stream has best video quality and includes whole coding data 210.

A sub bit-stream (to-be-transmitted coding data a which ranges from 0 to a, or to-be-transmitted coding data b which ranges from 0 to b) can be generated from the scalable base stream according to a bandwidth supported by a network or a specification of a user terminal.

A sub bit-stream a 220 includes to-be-transmitted coding data a. A sub bit-stream b 230 includes the to-be-transmitted coding data b.

The scalable base bit-stream or the sub bit-stream a or the sub bit-stream b consists of one or more scalable layers p1, p2, . . . , pm.

The scalable base bit-stream consists of only one bit-stream having all scalable layers p1 to pm.

The rest of sub bit-streams include specific scalable layers (p1 to pi for the sub bit-stream a, and p1 to p3 for the sub bit-stream b) selected from the scalable layers p1 to pm.

Since the SVC data is stored in each scalable layer, the data has to be accessible for each scalable layer.

FIG. 3 illustrates a file format of a multimedia file.

In general, video content stored in a file can be reproduced starting from a specific time point when access to the time point can be made to fetch data.

Therefore, actual media data resulted from coding of the content is separately stored in a media data portion.

Random access information, which is used when random access is made to the time point, is separately collected and stored in a track portion of the metadata.

As a result, when the time point needs to be randomly accessed during reproducing the actual content, a desired media data location is found by using only the metadata containing the random access information.

In the conventional content, a minimum access unit of the random access information is one frame unit.

In the case of SVC video content, one frame consists of a plurality of scalable layers.

The SVC data can be used for each salable layer only when the data is accessible for each scalable layer.

### DETAILED DESCRIPTION OF THE INVENTION

### Technical Problem

The present invention provides a method and apparatus for transmitting and receiving scalable video coding (SVC) data for each scalable layer.

### Technical Solution

The present invention provides a method and apparatus for transmitting and receiving an SVC file for each scalable layer wherein the SVC file can be accessed for each scalable layer by allowing metadata to contain a layer descriptor in a network abstraction layer unit (NALU) or in a byte unit.

### ADVANTAGEOUS EFFECTS

According to the present invention of a method and apparatus for transmitting and receiving a scalable video coding (SVC) file for each scalable layer, SVC data can be randomly accessed or transmitted/received for each scalable layer by proving a layer descriptor formed in a network abstraction layer unit (NALU) or in a byte unit to metadata of the SVC file.

### DESCRIPTION OF THE DRAWINGS

The above and other features and advantages of the present invention will become more apparent by describing in detail exemplary embodiments thereof with reference to the attached drawings in which:

FIG. 1 is a view for explaining the concept of scalable video coding (SVC);

FIG. 2 illustrates a configuration of a scalable layer of SVC data;

FIG. 3 illustrates a file format of a multimedia file;

FIG. 4 is a view for explaining a layer descriptor which allows SVC data to be accessible for each scalable layer according to an embodiment of be present invention;

FIG. 5 is a block diagram illustrating an apparatus for transmitting and received SVC data for each scalable layer according to an embodiment of the present invention; and

FIG. 6 is a flowchart illustrating a method of transmitting and receiving SVC data for each scalable layer according to an embodiment of the present invention.

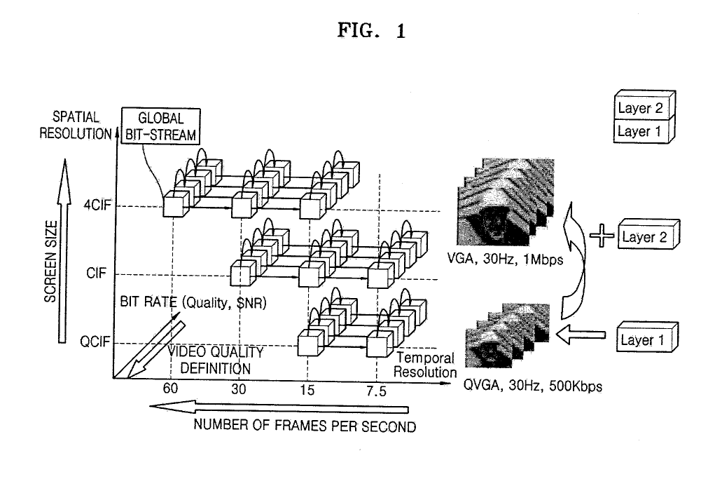

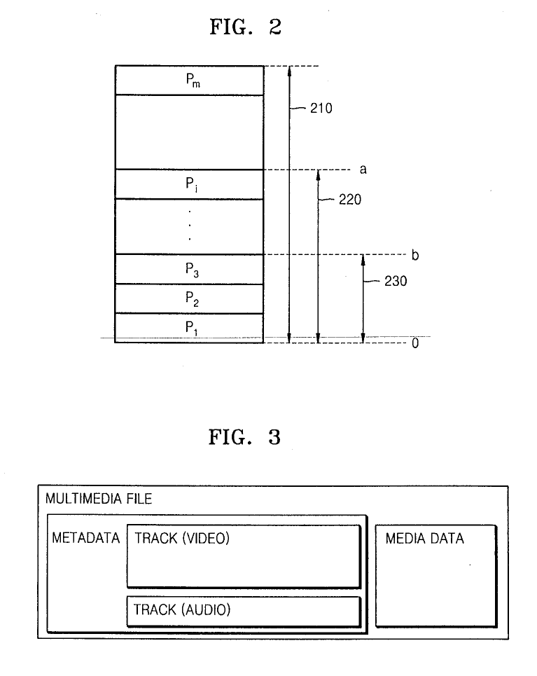

### BEST MODE

Hereinafter, exemplary embodiments of the present invention will be described in detail with reference to the accompanying drawings.

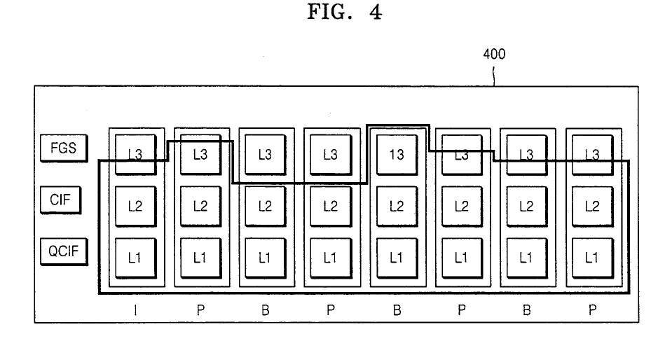

FIG. 4 is a view for explaining a layer descriptor which allows scalable video coding (SVC) data to be accessible for each scalable layer according to an embodiment of the present invention.

Referring to FIG. 4, one frame of SVC content consists of one or more scalable layers. A whole frame 400 of L1, L2, and L3 may be divided into eight portions.

A basic unit of each scalable layer is called a network abstraction layer unit (NALU).

Therefore, random access can be made for each scalable layer only when a random access unit can be determined to be the NALU within one frame.

Preferably, successful random access is ensured for each NALU only when the random access unit can be determined to be the byte unit.

A portion indicated by the solid line in FIG. 4 shows a part of whole content that has to be transmitted (only this part is transmitted after being truncated from the whole content).

Regarding first, second, sixth, seventh, and eighth frames of FIG. 4, an NALU L1 corresponding to a first layer and an NALU L2 corresponding to a second layer are all transmitted. However, for an NALU L3 corresponding to a third layer, a specific byte is truncated and transmitted. Thus, the LALU L3 is partially transmitted only up to a specific portion.

Regarding third, fourth, and fifth frames, only a part of one frame is transmitted. Still in this case, partial transmission is achieved in the basic unit of NALU. Transmission is carried out up to the second layer NALU-L2 in the third and fourth frames and up to the third layer NALU-L3 in the fifth frame.

Metadata of random access information further contacts a layer descriptor. The layer descriptor has the following information.

1. User layer number information (num_of_active_NALU) indicating the number of one or more scalable layers used in each frame. That is, num_of active_NALU indicates the number of NALUs existing in one frame.

2. Truncated data_length information (data_length) use for transmitting a fine granular scalable (FGS) layer, if a lastly used scalable layer is the FGS layer. That is, data_length indicates a byte unit to be used while the last NALU is transmitted.

The layer description may be a chunk descriptor that includes one or more frames and represents access information of a scalable layer in a chunk unit.

Preferably, the layer descriptor may further include an FGS identifier that indicates whether the lastly used scalable layer is the FGS layer.

A pseudo-code for the layer descriptor will be described.

Case 1 shows an example in which a function proposed in the present invention is included in the existing SampleToChunkBox function by using num_of_active_NALU and data_length.

Case 2 shows an example in which num_of active_NALU and data_length are separated while the exiting SampleToChunkBox function is used without alteration.

In the aforementioned pseudo-code, if required data portion is assigned up to a specific NALU within one frame, the number of required NALUs is set to num_of_active_NALU.

In addition, if the last NALU has to be partially assigned in the byte unit, truncated_FGS_NAL_flag is set to 1. Otherwise, truncated_FGS_NAL_flag is set to 0.

If truncated_FGS_NAL_flag is set to 1, the exact number of bytes to be partially assigned to each frame (or each sample in the case of pseudo-code) is written.

(Case1)
aligned(8) class SubSampleToChunkBox

extends FullBox(‘sstc’, version = 0, 0) {
unsigned int(32) entry_count;
for (i=1; i ≦ entry_count; i++) {

unsigned int(32) first_chunk;
unsigned int(32) samples_per_chunk;
unsigned int(32) sample_description_index;
unsigned int(16) num_of_active_NALU;
unsigned int(8) truncated_FGS_NAL_flag;
if(truncated_FGS_NAL_flag==1) {

for (j=1; j ≦ samples_per_chunk; j++) {

unsigned int([SVCDecoderConfigurationRecord.LengthSizeMinusOne+1)*8)

data_length;

}

}

}

}
(Case 2)
aligned(8) class SubSampleToChunkBox

extends FullBox(‘sstc’, version = 0, 0) {
unsigned int(32) entry_count;
for (i=1; i ≦ entry_count; i++) {

unsigned int(16) num_of_active_NALU;
unsigned int(8) truncated_FGS_NAL_flag;
if(truncated_FGS_NAL_flag==1) {

for (j=1; j ≦ samples_per_chunk; j++) {

unsigned int([SVCDecoderConfigurationRecord.LengthSizeMinusOne+1)*8)

data_length;

}

}

}

}

According to the layer descriptor, in the case shown in FIG. 4, content of SubSampleToChunkBox will be written in the metadata of the SVC file in practice as follows.

| | |
|---|---|
| entry_count | 1 |
| first_chunk | 1 |
| samples_per_chunk | 8 |
| sample_description_index | 1 |
| num_of_active_NALU | 3 |
| truncated_FGS_NAL_flag | 1 |
| data_length | 23, 42, 0, 0, 56, 40, 34, 34 |

Referring to SubSampleToChunkBox, entry_count is 1, that is, only one entry exists. This is because the whole frame of FIG. 4 is a track consisting of eight portions.

Only one chunk exists in the track of FIG. 4. Thus, first_chunk is 1.

The number of frames to be described by the chunk of FIG. 4 is eight. Thus, samples_per_chunk is 8.

In the whole frame consisting of eight portions of FIG. 4, each portion to be transmitted includes three NALUs. However, the number of bytes partially assigned to the last NALU differs.

Thus, in SubSampleToChunkBox, num_of_active_ALU is set to 3. Different transmission byte sizes are respectively assigned to the last NALU for each frame.

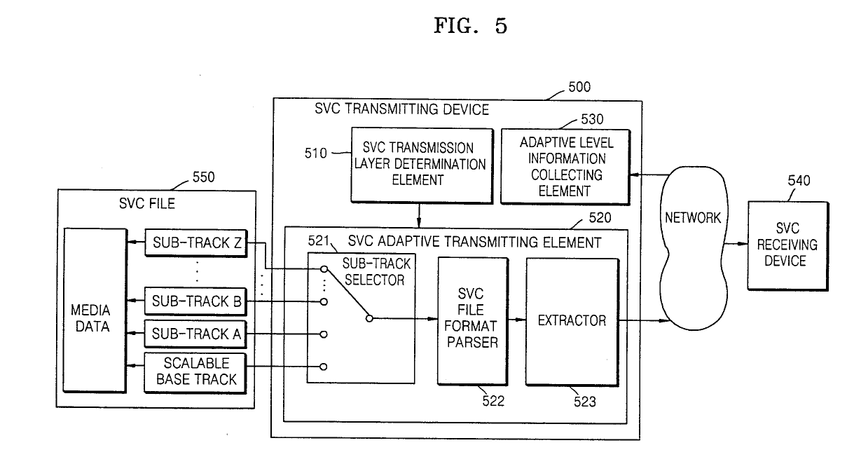

FIG. 5 is a block diagram illustrating an apparatus for transmitting and receiving SVC data for each scalable layer according to an embodiment of the present invention.

Referring to FIG. 5, the apparatus includes an SVC transmitting device 500 and an SVC receiving device 540.

The SVC transmitting device 500 includes an SVC transmission layer determination element 510 and an SVC adaptive transmitting element 520.

Among scalable layers of SVC content, the SVC transmission layer determination element 510 determines a transmission scalable layer to be transmitted to a network.

That is, the SVC transmission layer determination element 510 determines content (sub content) that can be optimally transmitted among SVC content (whole content).

Among the SVC content, the transmission scalable layer to be transmitted to the network is determined according to adaptive level information.

The adaptive level information is collected from the network so as to determine an adaptive degree of scalable coding. Examples of the adaptive level information include network state information collected from the network and service information selected by a user.

The SVC transmitting device 500 may further include an adaptive level information collecting element 530 which collects the adaptive level information.

The SVC adaptive transmitting element 520 transmits a bit-stream which is generated by extracting the transmission scalable layer from an SVC file 550 containing SVC data.

The SVC adaptive transmitting element 520 includes a sub-track selector 521, an SVC file format parser 522, and an extractor 523.

The sub-track selector 521 selects a sub-track according to the transmission scalable layer determined by the SVC transmission layer determination element 510.

The SVC file 550 containing SVC data includes one or more sub-tracks so as to generate a bit-stream formed in the basic unit of scalable layer.

In the sub-track, the SVC data is accessible for each scalable layer according to the layer descriptor.

The SVC file format parser 522 parses the SVC, file 550 containing the sub-track selected from the sub-track selector 521.

The extractor 523 transmits a bit-stream generated by extracting one or more transmission scalable layers from the parsed SVC file 550.

Accordingly, the SVC transmitting device 500 allows the SVC data to be transmitted for each scalable layer.

The SVC receiving device 540 receives the bit-stream transmitted from the SVC transmitting device 500 and then provides the bit-stream to the user.

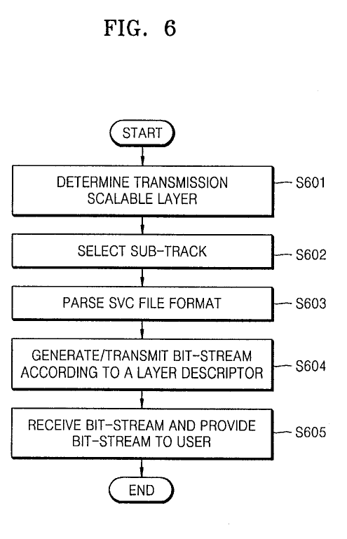

FIG. 6 is a flowchart illustrating a method of transmitting and receiving SVC data for each scalable layer according to an embodiment of the present invention.

A transmission scalable layer to be transmitted to a network is determined among scalable layers of SVC content (operation S601).

Specifically, in this operation, content (sub content) that can be optimally transmitted is determined among SVC content (whole content).

Among the SVC content, the transmission scalable layer to be transmitted to the network is determined according to adaptive level information.

The adaptive level information is collected from the network so as to determine an adaptive degree of scalable coding. Examples of the adaptive level information include network state information collected from the network and service information selected by a user.

The SVC file includes one or more sub-tracks containing a layer descriptor that indicates access information of one or more scalable layers used in each frame.

A bit-stream formed in the basic unit of scalable layer is generated according to the layer descriptor (operations S602 to S604).

Specifically, one sub-track is selected from one or more sub-tracks included in the SVC file so as to generate the bit-stream formed in the basic unit of scalable layer (operation S602).

The SVC file is parsed (operation S603).

A bit-stream is generated by extracting a transmission scalable layer from the parsed SVC file and is then transmitted (operation S604).

The bit-stream is received and provided to the user (operation S605).

As a result, the SVC data can be transmitted and received for each scalable layer by accessing to the data for each scalable layer.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

### MODE OF THE INVENTION

According to an aspect of the present invention, there is provided a method of transmitting an SVC file for each scalable layer, the method comprising: determining a transmission scalable layer to be transmitted to a network from one or more scalable layers included in each frame of media data of the SVC file, according to adaptive level information collected from the network so as to determine an adaptive degree of scalable coding; and transmitting a bit-stream generated by extracting the transmission scalable layer from the media data of the SVC file, according to a layer descriptor that indicates access information of the scalable layer used in each frame of the SVC file.

In the aforementioned aspect of the present invention, the transmitting of a bit-stream may further comprise: selecting one sub-track from one or more sub-tracks for generating a bit-stream in the basic unit of scalable layer, according to the layer descriptor; parsing the SVC file including metadata containing the selected sub-track, according to the layer descriptor; and transmitting the bit-stream generated by extracting one or more of the transmission scalable layers from the media data of the parsed SVC file.

According to another aspect of the present invention, there is provided a method of transmitting/receiving an SVC file for each scalable layer, the method comprising: transmitting the SVC file by extracting one or more of scalable layers from media data of the SVC file and by generating a bit-stream formed in the basic unit of scalable layer, according to a layer descriptor indicating access information of one or more of the scalable layers included in each frame of the SVC file; and receiving the SVC file by receiving the transmitted bit-stream and by providing a whole or part of the bit-stream to a user.

According to another aspect of the present invention, there is provided an SVC transmitting device comprising: an SVC transmission layer determination element determining a transmission scalable layer to be transmitted to a network from one or more scalable layers included in each frame of media data of the SVC file, according to adaptive level information collected from the network so as to determine an adaptive degree of scalable coding; and an SVC adaptive transmitting element transmitting a bit-stream generated by extracting the transmission salable layer from the media data of the SVC file, according to a layer descriptor that indicates access information of the scalable layer used in each frame of the SVC file.

In the aforementioned aspect of the present invention, the SVC adaptive transmitting element may further comprise: a sub-track selector selecting one sub-track from one or more sub-tracks for generating a bit-stream formed in the basic unit of scalable layer, according to the layer descriptor; an SVC file format parser parsing the SVC file including metadata containing the selected sub-track, according to the layer descriptor; and an SVC adaptive transmitter transmitting the bit-stream generated by extracting one or more of the transmission scalable layers from the media data of the parsed SVC file.

According to another aspect of the present invention, there is provided an SVC transmitting/receiving apparatus comprising: an SVC transmitting device transmitting the SVC file by extracting one or more of the scalable layers from media data of the SVC file and by generating a bit-stream formed in the basic unit of scalable layer, according to a layer descriptor indicating access information of one or more of the scalable layers included in each frame of the SVC file; and an SVC receiving device receiving the SVC file by receiving the transmitted bit-stream and by providing a whole or part of the bit-stream to a user.

In the aforementioned aspect of the present invention, the layer descriptor may include: num_of_active_NALU information portion indicating the number of the one or more of the scalable layers used in each frame; and/or, if a last scalable layer of the scalable layers is an FGS (fine granular scalable) layer, a data_length information portion indicating length information on truncated data used for transmitting the FGS layer.

In addition, num_of_active_NALU information may be described in an NALU (network abstraction layer unit) and data_length information may be described in a byte unit.

Accordingly, SVC data can be randomly accessed and thus transmitted/received for each scalable layer by proving a layer descriptor formed in a network abstraction layer unit (NALU) or in a byte unit to metadata of an SVC file.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

1. A method of transmitting an SVC (scalable video coding) file for each scalable layer, the method comprising:
determining a transmission scalable layer to be transmitted to a network from one or more scalable layers included in each frame of media data of the SVC file, according to adaptive level information collected from the network so as to determine an adaptive degree of scalable coding; and
transmitting a bit-stream generated by extracting the transmission scalable layer from the media data of the SVC file, according to a layer descriptor that indicates access information of the scalable layer used in each frame of the SVC file.

2. The method of claim 1, wherein the transmitting of a bit-stream further comprises:
selecting one sub-track from one or more sub-tracks for generating a bit-stream in the basic unit of scalable layer, according to the layer descriptor;
parsing the SVC file including metadata containing the selected sub-track, according to the layer descriptor; and
transmitting the bit-stream generated by extracting one or more of the transmission scalable layers from the media data of the parsed SVC file.

3. The method of claim 1 or 2, wherein the layer descriptor includes: num_of_active_NALU information portion indicating the number of the one or more of the scalable layers used in each frame; and/or, if a last scalable layer of the scalable layers is an FGS (fine granular scalable) layer, a data_length information portion indicating length information on truncated data used for transmitting the FGS layer.

4. The method of claim 3, wherein num_of_active_NALU information is described in an NALU (network abstraction layer unit) and data_length information is described in a byte unit.

5. The method of claim 3, wherein the layer descriptor is a chunk descriptor that indicates access information of the scalable layers in the unit of chunk containing one or more frames.

6. The method of claim 3, wherein the layer descriptor indicates whether the last scalable layer of the one or more of the scalable layers used in each frame is the FGS layer.

7. The method of claim 1, further comprising collecting the adaptive level information, wherein the adaptive level information includes network state information collected from the network and/or service information selected by a user.

8. A method of transmitting/receiving an SVC (scalable video coding) file for each scalable layer, the method comprising:
transmitting the SVC file by extracting one or more of scalable layers from media data of the SVC file and by generating a bit-stream formed in the basic unit of scalable layer, according to a layer descriptor indicating access information of one or more of the scalable layers included in each frame of the SVC file; and
receiving the SVC file by receiving the transmitted bit-stream and by providing a whole or part of the bit-stream to a user.

9. The method of claim 8, wherein the layer descriptor includes:
num_of_active_NALU information portion indicating the number of the one or more of the scalable layers used in each frame; and/or, if a last scalable layer of the scalable layers is an FGS (fine granular scalable) layer, a data_length information portion indicating length information on truncated data used for transmitting the FGS layer.

10. The method of claim 9, wherein num_of_active_NALU information is described in an NALU (network abstraction layer unit) and data_length information is described in a byte unit.

11. The method of claim 9, wherein the layer descriptor is a chunk descriptor that indicates access information of the scalable layers in the unit of chunk containing one or more frames.

12. The method of claim 9, wherein the layer descriptor indicates whether the last scalable layer of the one or more of the scalable layers used in each frame is the FGS layer.

13. A method of accessing to an SVC (scalable video coding) file for each scalable layer, in which media data of the SVC file is accessed for each scalable layer according to a layer descriptor indicating access information of one or more of the scalable layers used in each frame of the SVC file.

14. A method of accessing to an SVC (scalable video coding) file for each scalable layer, in which a bit-stream formed in the basic unit of scalable unit is generated according to one or more sub-tracks including a layer descriptor indicating access information of one or more of the scalable layers used in each frame of the SVC file.

15. The method of claim 13 or 14, wherein the layer descriptor includes: num_of_active_NALU information portion indicating the number of the one or more of the scalable layers used in each frame; and/or, if a last scalable layer of the scalable layers is an FGS (fine granular scalable) layer, a data_length information portion indicating length information on truncated data used for transmitting the FGS layer.

16. The method of claim 15, wherein num_of_active_NALU information is described in an NALU (network abstraction layer unit) and data_length information is described in a byte unit.

17. The method of claim 15, wherein the layer descriptor is a chunk descriptor that indicates access information of the scalable layers in the unit of chunk containing one or more frames.

18. The method of claim 15, wherein the layer descriptor indicates whether the last scalable layer of the one or more of the scalable layers used in each frame is the FGS layer.

19. An SVC (scalable video coding) transmitting device comprising:
an SVC transmission layer determination element determining a transmission scalable layer to be transmitted to a network from one or more scalable layers included in each frame of media data of the SVC file, according to adaptive level information collected from the network so as to determine an adaptive degree of scalable coding; and
an SVC adaptive transmitting element transmitting a bit-stream generated by extracting the transmission scalable layer from the media data of the SVC file, according to a layer descriptor that indicates access information of the scalable layer used in each frame of the SVC file.

20. The SVC transmitting device of claim 19, wherein the SVC adaptive transmitting element further comprises:
a sub-track selector selecting one sub-track from one or more sub-tracks for generating a bit-stream formed in the basic unit of scalable layer, according to the layer descriptor;
an SVC file format parser parsing the SVC file including metadata containing the selected sub-track, according to the layer descriptor; and
an extractor transmitting the bit-stream generated by extracting one or more of the transmission scalable layers from the media data of the parsed SVC file.

21. The SVC transmitting device of claim 19 or 20, wherein the layer descriptor includes: num_of_active_NALU information portion indicating the number of the one or more of the scalable layers used in each frame; and/or, if a last scalable layer of the scalable layers is an FGS (fine granular scalable) layer, a data_length information portion indicating length information on truncated data used for transmitting the FGS layer.

22. The SVC transmitting device of claim 21, wherein num_of_active_NALU information is described in an NALU (network abstraction layer unit) and data_length information is described in a byte unit.

23. The SVC transmitting device of claim 21, wherein the layer descriptor is a chunk descriptor that indicates access information of the scalable layers in the unit of chunk containing one or more frames.

24. The SVC transmitting device of claim 21, wherein the layer descriptor further includes an FGS identifier indicating whether the last scalable layer of the one or more of the scalable layers used in each frame is the FGS layer.

25. The SVC transmitting device of claim 21, further comprising an adaptive level information collecting element collecting the adaptive level information, wherein the adaptive level information includes network state information collected from the network and/or service information selected by a user.

26. An SVC (scalable video coding) transmitting/receiving apparatus comprising:
an SVC transmitting device transmitting the SVC file by extracting one or more of the scalable layers from media data of the SVC file and by generating a bit-stream formed in the basic unit of scalable layer, according to a layer descriptor indicating access information of one or more of the scalable layers included in each frame of the SVC file; and
an SVC receiving device receiving the SVC file by receiving the transmitted bit-stream and by providing a whole or part of the bit-stream to a user.

27. The SVC transmitting/receiving apparatus of claim 26, wherein the layer descriptor includes: num_of_active_NALU information portion indicating the number of the one or more of the scalable layers used in each frame; and/or, if a last scalable layer of the scalable layers is an FGS (fine granular scalable) layer, a data_length information portion indicating length information on truncated data used for transmitting the FGS layer.

28. The SVC transmitting/receiving apparatus of claim 27, wherein num_of_active_NALU information is described in an NALU (network abstraction layer unit) and data_length information is described in a byte unit.

29. The SVC transmitting/receiving apparatus of claim 27, wherein the layer descriptor is a chunk descriptor that indicates access information of the scalable layers in the unit of chunk containing one or more frames.

30. The SVC transmitting/receiving apparatus of claim 27, wherein the layer descriptor further includes an FGS identifier indicating whether the last scalable layer of the one or more of the scalable layers used in each frame is the FGS layer.

31. An SVC (scalable video coding) file having media data containing one or more scalable layers in each frame, comprising a layer descriptor indicating access information of the scalable layers used in each frame so as to access to the media data for each scalable layer.

32. An SVC (scalable video coding) file having media data containing one or more scalable layers in each frame, comprising one or more sub-tracks for generating a bit-stream formed in the basic unit of scalable layer, according to a layer descriptor indicating access information of one or more of the scalable layers included in each frame of the SVC file.

33. The SVC file of claim 31 or 32, wherein the layer descriptor includes: num_of_active_NALU information portion indicating the number of the one or more of the scalable layers used in each frame; and/or, if a last scalable layer of the scalable layers is an FGS (fine granular scalable) layer, a data_length information portion indicating length information on truncated data used for transmitting the FGS layer.

34. The SVC file of claim 33, wherein num_of_active_NALU information is described in an NALU (network abstraction layer unit) and data_length information is described in a byte unit.

35. The SVC file of claim 33, wherein the layer descriptor is a chunk descriptor that indicates access information of the scalable layers in the unit of chunk containing one or more frames.

36. The SVC file of claim 33, wherein the layer descriptor further includes an FGS identifier indicating whether the last scalable layer of the one or more of the scalable layers used in each frame is the FGS layer.

37. A computer-readable medium having embodied thereon a computer program for executing the method of any one of claims 1 to 18.
